(19) United States
(12) Patent Application Publication
(10) Pub. No.: US 2012/0155777 A1
(43) Pub. Date: Jun. 21, 2012

(54) Method and an apparatus for performing a cross-calculation

(76) Inventors: Florian Schweiger, Munich (DE); Michael Eichhorn, Munich (DE); Georg Schroth, Munich (DE); Eckehard Steinbach, Olching (DE); Michael Fahrmair, Munich (DE)

(21) Appl. No.: 13/373,763

(22) Filed: Nov. 29, 2011

(30) Foreign Application Priority Data
Nov. 29, 2010 (EP) 10193008.9

(51) Int. Cl. G06K 9/52

(52) U.S. Cl. 382/207

(57) ABSTRACT

A computer implemented signal processing method to perform a cross-calculation between a first and a second signal by performing a cross-correlation for segments of said first signal with said second signal to obtain a plurality of partial cross correlation functions, obtaining a combined cross-correlation function by combining said partial cross-correlation functions to obtain a combined cross-correlation function, applying an outlier detection or outlier removal approach to identify or remove those segments which are disturbed or corrupted, and re-combining said partial cross-correlation functions without the ones which have been identified as disturbed or corrupted to obtain a less disturbed or less corrupted final cross-correlation function.

### RELATED APPLICATIONS

This application claims priority under 35 U.S.C. §119 to European Patent Application No. 10193008.9 filed on Nov. 29, 2010, the entire content of which is hereby incorporated by reference.

### BACKGROUND OF THE INVENTION

1. Field of the Invention

The present invention relates to a method and an apparatus for performing a cross-calculation between a first and a second signal.

2. Description of the Related Art

Cross-correlation is a standard tool in signal processing with numerous applications ranging from telecommunication to image processing. Its basic purpose is to retrieve the fundamental similarity between two signals which is otherwise obscured by adverse effects such as noise, partial occlusion etc. The cross-correlation function of two one-dimensional, discrete-time and real-valued signals is defined as

$$c ( Δ t ) = ( a * b ) ( Δ t ) = {\sum }_{t ∈ τ} a ( t + Δ t ) b ( t ) \qquad ( 1 )$$

where T is the set of sample indices where both a(t+Δt) and b(t) are unequal to zero.

For every offset Δt, the cross-correlation function measures the similarity between the first signal and the second, accordingly shifted signal. If there is a statistical correlation between the two signals, the cross-correlation function will attain high values for the respective offsets. This is illustrated in FIG. 1 which shows in the left-hand part samples from signals a and b that are one unit apart and are obviously highly correlated. Neglecting noise components, the respective samples are even identical in this example. The corresponding cross-correlation function c shown in the right-hand part reflects this with a maximum at offset Δt=1.

More precisely, if the random processes generating the samples of a and b are jointly ergodic and zero-mean, then c(Δt) is an estimate for the covariance of the two processes shifted with respect to each other by Δt.

Cross-correlation plays an important role in various fields. Generally speaking, it is employed whenever a certain pattern needs to be detected in a signal or when the shift between two matching signals is to be determined.

In telecommunication for instance, cross-correlation is used to detect template signals of known shape in a noisy receive signal. This is referred to as the concept of matched filters (see e.g. G. Turin. An introduction to matched filters. Information Theory, IRE Transactions on, 6(3):311-329, 1960). Another application is to determine the time-of-arrival difference of signals in order to measure, e.g., distances or velocities (see e.g. US Patent Application 2010/0027602 A1).

In image processing two-dimensional cross-correlation function's are used for pattern matching, e.g., in order to identify known shapes in an image, or to determine the displacement of certain pixel regions between two images (see e.g., Brunelli. Template matching techniques in computer vision. 2008).

While cross-correlation is applied in a wide variety of technical fields such as telecommunications or image processing, it is prone to failure if the signals are excessively corrupted. While it is relatively insusceptible to additive white noise, the effects of non- stationary disturbances are more severe. If the signals include, e.g., dominant crosstalk components, or if burst-wise errors spoil the measurements temporarily, the cross-correlation function can contain side maxima in the same order of magnitude as the peak at the true offset. In image processing applications, this can be caused for example by spatial occlusions. FIG. 2 illustrates this effect schematically. In this example, there is shown an example for a local disturbance of the signal b(t) at time point 4 (see left-hand part, lower graph), e.g. due to crosstalk. This can lead to a significant secondary peak in the cross-correlation function, as shown in the graph on the right-hand side of FIG. 2.

The plainest form of cross-correlation as defined in Equation (1) easily extends to more general cases. For the afore-mentioned image processing applications, e.g., two and higher dimensional signals need to be considered. Equation (2) gives the general n-dimensional version, which also accommodates complex valued input signals.

$$c ( Δ t ) = {\sum }_{{t}_{1}} … {\sum }_{{t}_{N}} a * ( t + Δ t ) b ( t ) , t , Δ t ∈ {ℤ}^{N} \qquad ( 2 )$$

A special case of cross-correlation is auto-correlation where a signal is correlated with itself, i.e., a≡b. Auto-correlation is, e.g., useful to identify periodic patterns in a signal.

Another variant commonly used in image processing is normalized cross correlation as defined in Equation (3).

$$\overline{c} ( Δ t ) = {\sum }_{t ∈ τ} \frac{[ a ( t + Δ t ) - \overline{a} ( Δ t ) ] [ b ( t ) - \overline{b} ( Δ t ) ]}{{σ}_{a} ( Δ t ) {σ}_{b} ( Δ t )} \qquad ( 3 )$$

Here, x and σₓ denote the mean and standard deviation of signal x within the overlap region of a and b shifted by Δt. Normalized cross-correlation is equivalent to the correlation coefficient between the accordingly shifted signals. Its advantage is that it allows for a fair comparison of signals on different overall levels.

Yet another variation is rank correlation, which does not consider the actual values of the input signals but rather their ranked order. This increases robustness against isolated errors, which is comparable to the advantages of the median filter over regular averaging. Two widely used rank correlation methods are the so-called Spearman's ρ and Kendall's τ (see e.g., G. Kendall and J. D. Gibbons. Rank correlation methods. 1990).

### SUMMARY OF THE INVENTION

According to one embodiment there is provided a computer-implemented signal processing method to perform a cross-calculation between a first and a second signal, said method comprising:

splitting the first signals into shorter segments of length M;

performing a cross-correlation for the segments of said first signal with said second signal to obtain a plurality of partial cross correlation functions;

obtaining a combined cross-correlation function by combining said partial cross-correlation functions to obtain a combined cross-correlation function;

applying an outlier detection or outlier removal approach to identify or remove those segments which are disturbed or corrupted, and wherein said outlier detection approach comprises:

comparing said individual partial cross-correlation functions with the combined partial cross correlation function to perform a consensus-check in order to check whether the partial cross correlation is in consensus with said combined cross-correlation function, and wherein said method further comprises:

re-combining said partial cross-correlation functions without the ones which are based on said segments which have been identified as disturbed or corrupted to obtain an less disturbed or less corrupted final cross-correlation result.

By identifying outliers among the partial cross-correlation functions based on performing a consensus-check, it is possible to obtain a better combined cross-correlation function free from distortions.

According to one embodiment the method further comprises:

calculating based on said combined partial cross-correlations a combined cross-correlation result as a candidate offset, and wherein

if the consensus- check results in that there is no consensus, treating said partial cross-correlation function as an outlier.

According to one embodiment the method further comprises:

selecting a set of shorter segments of length M;

calculating said combined cross-correlation based on the partial cross correlation functions of said selected set;

performing said consensus-check to identify the outliers among said partial cross-correlation functions of said set;

repeating said step of selecting a set of segments, calculating a combined cross-correlation and performing said consensus check for the individual partial cross-correlations which correspond to said segments until there has been found at least one set of segments which has no outliers or the segment which has the least number of outliers;

calculating the final combined cross-correlation function based on a set of segments which has no outliers or the least number of outliers.

In this manner the embodiment identifies among the possible combinations of PCCFs those which has not outliers or the least number of outliers and thereby the best final combined cross-correlation function.

According to one embodiment the combined cross-correlation is calculated based on a plurality of sets of segments which may have different numbers of segments, and wherein said final combined cross-correlation function is calculated based on the set of segments which has the maximum number of segments among the sets of segments for which no outlier has been found.

In this manner different samples which have different numbers of segments may be considered to find the optimum combination of segments for obtaining the final combined cross-correlation function.

According to one embodiment a combined partial cross-correlation function yields a candidate offset, and said outlier detection or removal approach comprises one of the following:

comparing the absolute or the relative value of a partial cross-correlation function at the candidate offset with the combined partial cross-correlation value at the candidate offset;

comparing the curvature of the partial cross-correlation function at the candidate offset with the with a certain threshold;

comparing the distance in samples from the candidate offset to the closest significant local maximum of the partial cross-correlation function as to whether it is beyond a certain threshold.

These are specific ways of performing the consensus check for the individual cross-correlation functions.

According to one embodiment said outlier detection or removal approach comprises one of the following:

a RANSAC algorithm;

a least median of estimated squares algorithm;

an M-estimator.

These are examples for the outlier detection approach.

According to one embodiment said outlier detection approach is a RANSAC algorithm in which the model which is to be fitted is the peak of the cross-correlation value between the first and second signal, and the data points used in the fitting are the respective peaks of the partial cross correlation functions, the values of which, after removal of the disturbed partial cross-correlation functions, are combined to obtain the total cross correlation function.

This is a specific preferable embodiment of implementing a RANSAC algorithm.

According to one embodiment said consensus check comprises:

checking for each partial cross-correlation function whether the deviation between the peak of the partial cross-correlation functions and the peak of the combined cross-correlation function lies within a certain threshold to identify outliers.

This is a particular example of a preferable implementation of a consensus-check.

According to one embodiment said method is applied to find the temporal offset between two video sequences of the same event, possibly taken from different perspectives, said method comprising:

transforming the video data of said two scenes into respective on-dimensional time series;

obtaining the cross-correlation said two time series as defined in one of the preceding claims in order to determine based on the obtained cross-correlation the temporal offset between said two video sequences.

In this manner the method can be applied to determine the temporal relationship between videos.

According to one embodiment method further comprises:

treating the obtained on-dimensional signals as quasi stationary and/or normalize them with their global means and standard deviations.

In this manner the signals may be prepared for the cross-correlation.

According to one embodiment method further comprises:

in order to find the peak candidates in the partial cross correlation functions, applying an approach to mitigate noise, wherein sad approach comprises:

apply morphological closure, or

repeatedly compute the convex hull of the resulting cross-correlation function in order to preserve only its meaningful peaks.

In this manner the influence of noise can be reduced.

According to one embodiment there is provided a signal processing apparatus to perform a cross-calculation between a first and a second signal, said apparatus comprising:

a module for splitting the first signals into shorter segments of length M;

performing a cross-correlation for the segments of said first signal with said second signal to obtain a plurality of partial cross correlation functions;

a module for obtaining a combined cross-correlation function by combining said partial cross-correlation functions to obtain a combined cross-correlation function;

a module for applying an outlier detection or outlier removal approach to identify or remove those segments which are disturbed or corrupted, and wherein said outlier detection approach comprises:

comparing said individual partial cross-correlation functions with the combined partial cross correlation function to perform a consensus-check in order to check whether the partial cross correlation is in consensus with said combined cross-correlation function, and wherein said apparatus further comprises:

a module for re-combining said partial cross-correlation functions without the ones which are based on said segments which have been identified as disturbed or corrupted to obtain an less disturbed or less corrupted final cross-correlation result.

In this manner an apparatus for carrying out an embodiment of the invention can be implemented.

According to one embodiment the apparatus further comprises:

a module for calculating said combined partial cross-correlation and a combined cross-correlation result as a candidate offset, and wherein

if the consensus- check results in that there is no consensus, treating said partial cross-correlation function as an outlier.

According to one embodiment the apparatus further comprises:

a module for selecting a set of shorter segments of length M;

a module for calculating said combined cross-correlation based on the partial cross correlation functions of said selected set;

a module for performing said consensus-check to identify the outliers among said partial cross-correlation functions of said set;

a module for repeating said step of selecting a set of segments, calculating a combined cross-correlation and performing said consensus check for the individual partial cross-correlations which correspond to said segments until there has been found at least one set of segments which has no outliers;

a module for calculating the final combined cross-correlation function based on a set of segments which has no outliers.

According to one embodiment there is provided a computer program comprising:

computer program code which when being executed on a computer enables said computer to carry out a method according to one of the embodiments of the invention.

### BRIEF DESCRIPTION OF THE DRAWINGS

FIG. 1 schematically illustrates the cross-correlation of two signals.

FIG. 2 schematically illustrates a local disturbance and its influence on a cross-correlation.

FIG. 3 schematically illustrates a RANSAC approach for fitting.

FIG. 4 schematically illustrates the partial cross correlation functions for the example videos shown in FIG. 5.

FIG. 5 schematically illustrates two videos used in an embodiment of the invention.

FIG. 6 schematically illustrates the conventional cross-correlation for the videos sown in FIG. 5.

FIG. 7 schematically illustrates the consensus-based cross-correlation for the videos sown in FIG. 5.

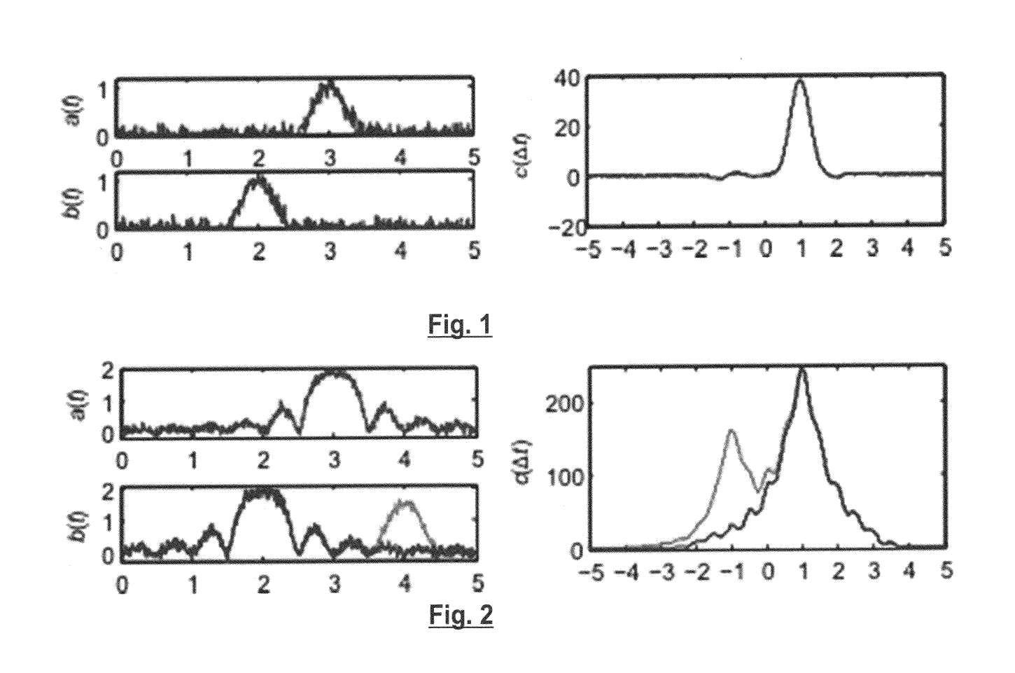

### DETAILED DESCRIPTION OF THE PREFERRED EMBODIMENTS

In the following embodiments of the invention will be described. First of all, however, some terms will be defined.

PCCF—partial cross-correlation functions

RANSAC—Random Sample Consensus

M-Estimators—are a broad class of estimators, which are obtained as the minima of sums of functions of the data

LMedS—Least Median of Squares

According to one embodiment there is provided a novel approach to make cross-correlation robust to sporadic disturbances like the ones discussed above. The approach is especially suitable for those cases where major parts of the signals are free from such errors, and only some, locally limited portions are corrupted. In such cases then the input data can hence be divided into good and bad segments, and one may use an established outlier removal strategy such as like for example the ransac algorithm to make this separation.

Random Sample Consensus (ransac) is an iterative algorithm to robustly fit a model to a set of measurements or data points (see e.g. M. A. Fischler and R. C. Bolles. Random sample consensus: A paradigm for model fitting with applications to image analysis and automated cartography. Communications of the ACM, 24(6):381-395, 1981). The fundamental difference to, e.g., least squares fitting is that initially just the minimum number of data points necessary to establish a model are used. These are selected randomly. At this stage, small errors in the measurements are not averaged out as efficiently. However, the main concern is to at first identify and eliminate grossly erroneous data points (referred to as outliers). This is achieved by testing all the measurements against the initially established model. Points that comply with the model are labeled inliers, the others deemed outliers. This process is repeated with a different set of randomly picked points, and reiterated as many times as necessary to be confident about having chosen an outlier-free set at least once. Eventually, the model with highest consensus, i.e., with the least: outliers, is accepted, and a final least squares fit is performed based on its inliers.

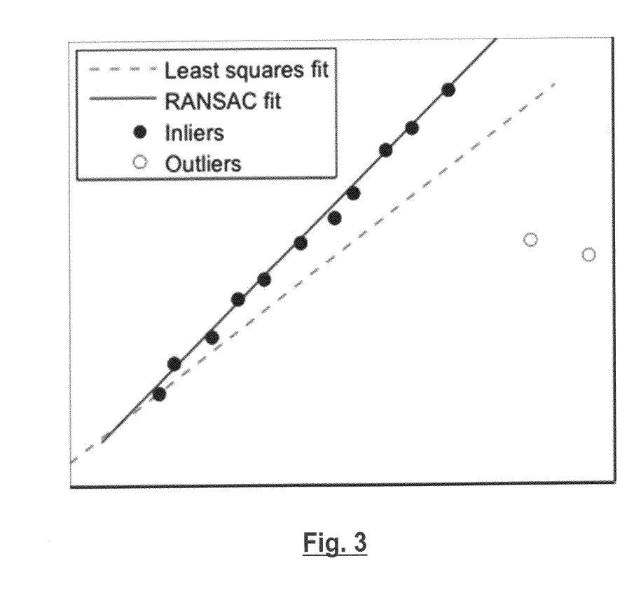

FIG. 3 compares the ransac strategy with standard least squares for the textbook example of 2D line fitting. In the example shown in FIG. 3 the majority of the given 2D points can be consistently modeled by a straight line. Two spurious points, however, spoil least square fitting. Ransac, on the other hand, can identify the two outliers and excludes them from consideration.

The proposed cross-correlation strategy can provided a versatile extension to achieve robustness to burst errors in the input signals. Moreover, it can replace conventional cross-correlation approaches irrespective of the actual application.

In the following there will be described some more concrete embodiments of the approach. Already now it should be mentioned, however, that the concretely involved parameters such as the segment length, the number of combined PCCFs, and the outlier classification strategy can be adapted individually to the specific signal class.

This especially also applies to the outlier classification strategy. While the embodiments described in the following are mainly based on ransac, the basic concept may equally be based upon any other outlier removal strategy, such as M-Estimators or LMedS.

According to one embodiment the method of performing a cross-calculation between two original signals which may be partly corrupted e.g. due to burst errors operates as follows
a. splitting one of the original signals into shorter segments of length M
b. cross-correlating each of them with the second signal to obtain partial cross-correlation functions (PCCF) and
c. (re-)combining PCCFs with a suitable outlier separation strategy in order to separate the corrupted segments from the valid ones.

According to one further embodiment the method of performing a cross-calculation between two signals which may be partly corrupted e.g. due to burst errors operates as follows.

In a first step:one of the original signals (the first signal) is splitted into shorter segments of length M (shorter than the original length L).

In a second step each of these shorter segments is cross-correlated with the second signal to obtain partial cross-correlation functions (PCCF).

In a third step the partial cross-correlation functions are combined to obtain a combined cross-correlation function.

Then, in a fourth step the partial cross-correlation functions are compared with the combined cross-correlation function to identify outliers by performing a consensus-check to check whether the PCCFs are in consensus with the combined cross-correlation function.

Then the PCCFs which have been identified as outliers are removed an the remaining PCCFs are re-combined to obtain a final combined cross-correlation function.

The step of performing a consensus-check in one embodiment may comprise the step of applying an outlier detection or outlier removal approach to identify or remove those segments which are disturbed or corrupted. In this step different outlier detection approaches may be used, one of them being the RANSAC approach.

Then there may be performed the re-combining of the partial cross-correlation functions without the ones which are based on said segments which have been identified as disturbed or corrupted to obtain an less disturbed or less corrupted (final) cross-correlation result.

In one embodiment the outlier detection approach is ransac, and the model to be fitted is the offset, hence a single scalar value which is the location of the peak of the cross-correlation function. The data points are the PCCFs, which are combined, i.e., summed up in order to determine potential candidate offsets. The sum of all PCCFs then yields the cross-correlation function of the original signals.

According to one embodiment the approach may be used to find the temporal offset between two video sequences of the same event but different perspective by:
a: reducing the video data to one-dimensional time series that reflect characteristic scene changes over time. For example, one may use for this purpose the bitrate of the video data as generated by an encoder, and as described for example in the European Patent application no. 09175917.5 to generate such time series.
b. Applying the correlation mechanism as described in one of the embodiments of the present invention to detect the temporal offset between the two video sequences.

Optionally the method may further include to treat the derived 1-D signals as quasi-stationary and normalize them with their global means and standard deviations before performing the cross correlation.

In the following some further embodiments will be described in somewhat more detail.

According to one embodiment one may consider the basic idea behind the described cross-correlation approach is to split one of the original signals into shorter segments of length M (which is smaller than the original signal length L), and to cross-correlate each of them with the second signal. The so obtained partial cross-correlation functions (PCCF) are then combined in a manner similar to a ransac-approach in order to separate the corrupted segments from the valid ones. In terms of ransac, the model to be fitted is the offset, hence a single scalar value.

The data points are the PCCFs, which are combined, i.e., summed up in order to determine potential candidate offsets. Indeed, the sum of all PCCFs cᵢ yields the cross-correlation function of the original signals:

$$\begin{matrix}{\sum }_{i} {c}_{i} ( Δ t ) = {\sum }_{i} {\sum }_{ι ∈ τ} a ( t + Δ t ) {b}_{i} ( t ) \\ = {\sum }_{ι ∈ τ} a ( t + Δ t ) {\sum }_{i} {b}_{i} ( t ) \\ = {\sum }_{ι ∈ τ} a ( t + Δ t ) b ( t ) \\ = c ( Δ t )\end{matrix}$$

By omitting outlier PCCFs in the above summation, it:becomes possible to exclude their influence on the resulting cross-correlation function.

There is a trade-off in choosing the number of PCCFs to be combined in every ransac step. In principle, it is desirable to use as many PCCFs as possible in order to obtain a maximally conclusive peak in the resulting cross-correlation function. Raising their number, however, also increases the chance of including outlier PCCFs. This decision depends on the expected burst error distribution and is application specific.

A similar choice has to be made for the segment length M. Using too few samples increases the risk to cut out segments that are not discriminative enough. On the other hand, too long segments are prone to contain corrupted samples.

The algorithm below summarizes the proposed cross-correlation according to one embodiment given two input signals a(t) and b(t).
1. Chop signal b(t) in segments bi(t) of length M
2. Compute the PCCFsci(Δt)=(a*bi)(Δt)
3. [repeat 3a/b/c until confidence is reached that one outlier-free PCCF set was selected]
   a. Make a random selection of s PCCFs and compute their sum
   b. Extract candidate offsets from that sum
   c. For every offset candidate, evaluate the number of inliers among the PCCFs
4. Select the offset with most inlierPCCFs
5. Optionally, re-compute the offset from the combination (sum) of inlierPCCFs

The particular way of implementing the step 3c is a matter of choice which can be chosen suitably by the skilled person. For example to determine the number of outliers and the number of inliers there may be checked whether the offsets of the PCCFs lie within a certain threshold of the combined offset value. The threshold may e.g. chosen as the standard deviation of the sample of PCCFs offset values, but other choices may be possible as well. The whole procedure of step 3 may be repeated until the selected set of PCCFs is such that it does not contain any outliers any more but instead—for a certain set of PCCFs—has only inliers.

Then, in step 4 there may be selected the set of PCCFs which has the largest number of inliers among those sets found in step 3 which only have inliers.

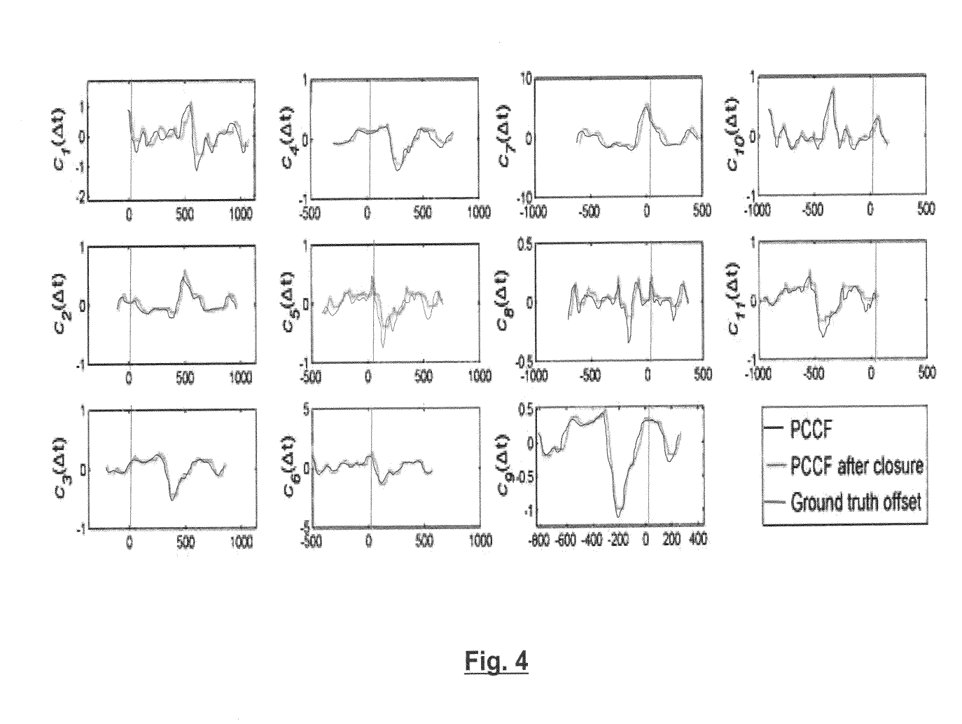

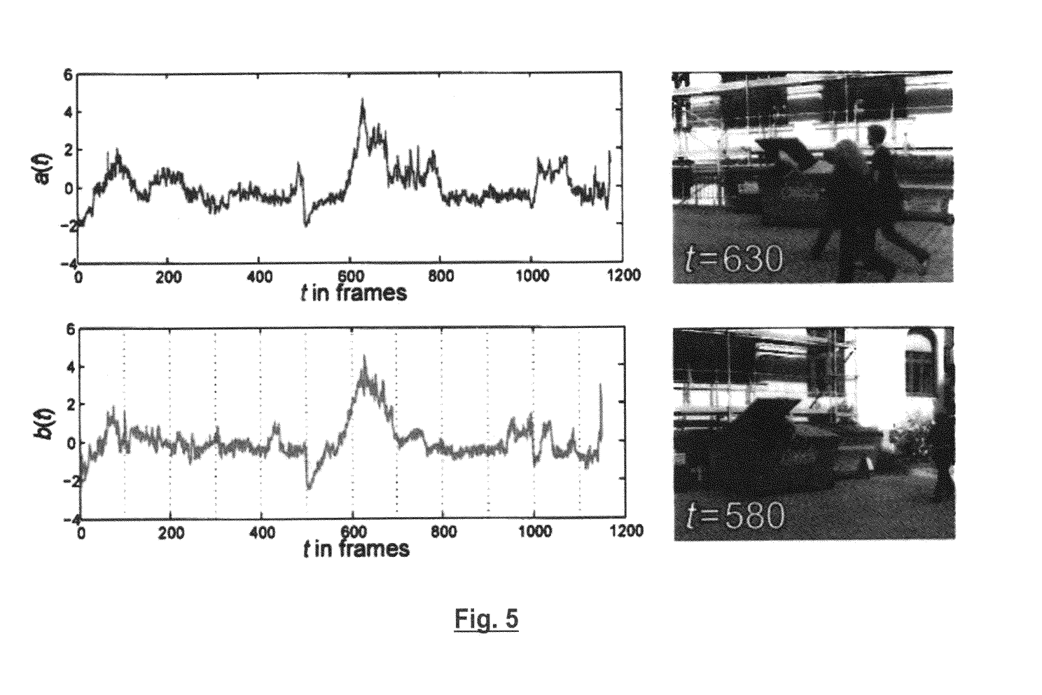

Depending on the application, the PCCFs and their combinations do not necessarily exhibit a single, conclusive peak. Instead, they may contain several local maxima of comparable strength, leading to more than one candidate offset. This effect is illustrated in FIG. 4 which shows partial cross correlations for the two video signals a(t) and b(t) shown in FIG. 5. FIG. 5 shows on the left-hand side two input signals a and b, and on the right-hand side it shows two synchronous frames of the video sequences of which the signals a(t) and b(t) have been derived from. One can see from the frames that obviously the video sequences are taken from different angles. The segmentation of signal b used in the present approach is indicated in FIG. 5 by the dotted vertical lines which are indicated at intervals of 100 frames.

The effect that there are more than one candidate offsets (cf. FIG. 4) is more pronounced when only a small number of PCCFs are combined or when each of them has been computed from very few samples.

In order to find the candidate offsets in the combination of a randomly selected PCCFs, noise effects may be mitigated in a first step. For that purpose one may according to one embodiment apply morphological closure or one may repeatedly compute the convex hull of the resulting cross-correlation function in order to preserve only its meaningful peaks. For the corresponding offset candidates, it is then checked how many of the single PCCFs support each one of them. This may be regarded as a “consensus check” in the sense that it is checked whether the candidate offset is in consensus with the individual offsets of the individual PCCFs.

Several aspects can be taken into account to do this consensus check:
the absolute or relative PCCF value at the examined offset,
the curvature of the PCCF at the examined offset,
the distance in samples from the examined offset to the closest significant local maximum of the PCCF,
or any combination of these and possibly other criteria.

The absolute (or relative) PCCF value of an individual PCCF at the candidate offset may be compared with the combined candidate value. If the difference is larger than a (predefined) threshold, then the individual PCCF may be regarded as not being in consensus with the combined PCCF (=the candidate value). The PCCF may therefore be regarded then as “outlier”.

The curvature of the PCCF at the examined offset may also be considered. E.g. if the curvature is significantly different from zero, e.g. beyond a certain threshold, then this may be regarded as an indication that the individual PCCF is an “outlier”, since at the candidate offset value the individual PCCF should have a curvature which indicates a maximum (i.e. a curvature of zero).

Another approach could be to consider the distance in samples from the examined candidate offset of the combined PCCF to the closes significant local maximum of a candidate PCCF. If this distance exceeds a certain (e.g. predetermined) value, then the PCCF may be regarded as an “outlier”, i.e. as not being in consensus with the candidate offset.

The description of the following embodiment will illustrate the different steps with a more concrete example.

The example application discussed in the following deals with the problem of video synchronization based on one-dimensional time-series extracted frame wise from two videos. This may e.g. just be the bitrate as a function of time (as e.g. described in European Patent Application no. 09175917.5 titled “Method and apparatus to synchronize video data”) or any other one-dimensional time dependent function. In such a case cross-correlation can be used to find the temporal offset between the two different time-series representing the two videos, and thus between the two videos.

In order to find the temporal offset between two video sequences, one approach is to reduce the video data to one-dimensional time series that reflect characteristic scene changes over time. For that purpose one may use, as mentioned, the method described in European Patent Application no. 09175917.5 titled “Method and apparatus to synchronize video data” to generate such time series. The used videos are captured with static cameras and show the same scene of a person acting in front of a static background. One may treat the derived 1-D signals as quasi-stationary and normalize them with their global means and standard deviations. This has beneficial effects similar to using normalized cross-correlation as defined in Equation (3).

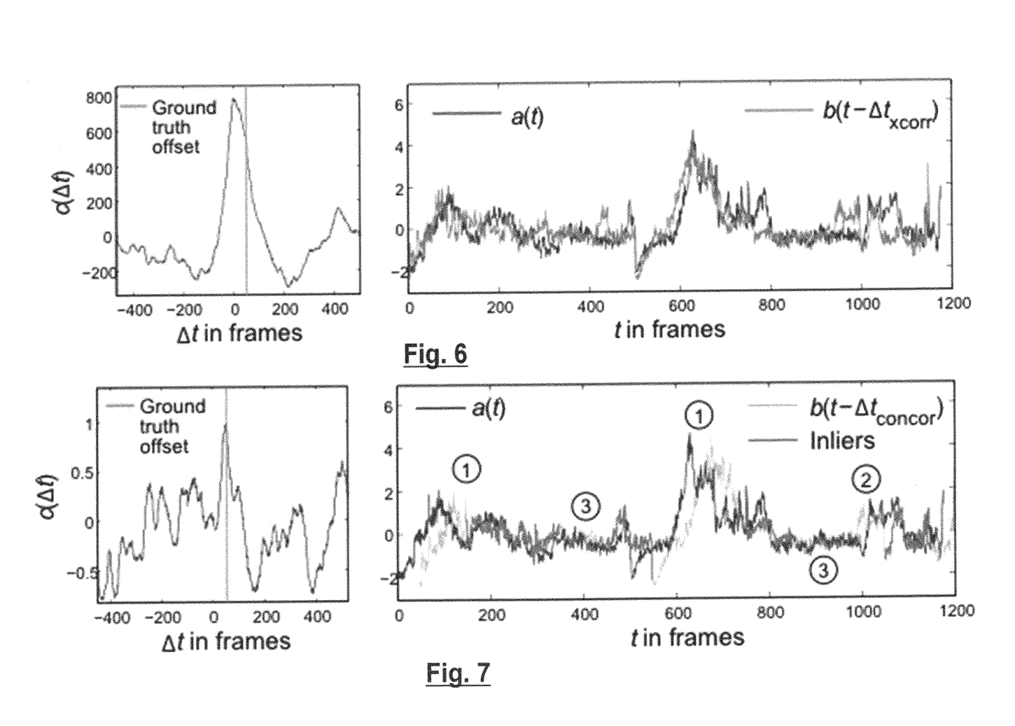

FIG. 5 shows on the left-hand side the two so obtained input signals together with two synchronous example frames from the respective videos on the right-hand side. Their regular cross-correlation function is plotted in FIG. 6 on the left-hand side which leads to an offset of 1 frame. The right-hand side of FIG. 6 shows the signals a and b superimposed at the offset of 1 frame as obtained by the “normal” conventional cross correlation. The deviation from the ground truth offset (=the “real” offset between the two videos) is caused by effects at the image boundaries. Due to the different viewpoints of the involved cameras, people entering and leaving the scene trigger fluctuations, which occur slightly delayed in the 1-D signals. The rather strong peak around frame 700 in both signals a and b is, e.g., caused by such a passer-by effect. Regular, conventional cross-correlation tends to align such dominant signal parts ignoring the smaller yet more consistent parts of the signals. As shown in this FIG. 6, the conventional cross-correlation of signals a and b yields the offset Δt_{xcon}=1 frame. This is due to the erroneous peak between frames 600 and 700 whose alignment is enforced.

The proposed cross-correlation approach according to one embodiment deals with this problem by expelling these singular segments, as shown in FIG. 7. The cross-correlation approach according to an embodiment of the invention yields the correct offset Δtcor=50 frames. In particular, it discards the segments bi which are marked by encircled numbers at the right-hand side of FIG. 7 and which are those parts where local maxima are caused by distortions, such as where (1) people walk into the scene from the right, (2) people walk in from the left, and (3) where there is not enough scene motion to reasonably establish temporal relationships between both videos. These portions (1), (2), and (3) are identified as “outliers” in the embodiment of the invention, since the consensus based approach indicates the portion cross-correlation functions which correspond to these distorted parts as not being in consensus with the resulting combined PCCF Therefore the PCCFs which correspond to these parts are expelled, and the resulting combined PCCF yields the “true” offset of 50 frames. The right-hand part of FIG. 7 shows the signals a and b, with b being shifted by the “true offset” of 50 frames as obtained by the consensus-based cross-correlation function shown on the left-hand side of FIG. 7.

Regarding the actual approach in this embodiment, for this evaluation experiment of the performance of the approach presented herein, the second signal was segmented into snippets with M=100 frames (step i of the above described algorithm). During the random selection step (3a) s=3 of the segments were combined to determine potential offsets. Prior to local maximum extraction (3b), and for the verification step (3c), the respective signals were filtered by closure with a structuring element of width 51 frames. In this implementation, a PCCF votes for a given offset candidate (=is considered to be an “inlier”) if its closest local maximum is no further than 10 frames away. But this value is a matter of choice and may be suitably chosen byte skilled person. The question how to decide whether a OCCF is in “consensus” with the combined PCCF can be decided an a manifold of ways.

It will be readily apparent to the skilled person that the methods, the elements, units and apparatuses described in connection with embodiments of the invention may be implemented in hardware, in software, or as a combination of both. In particular it will be appreciated that the embodiments of the invention and the elements of modules described in connection therewith may be implemented by a computer program or computer programs running on a computer or being executed by a microprocessor. Any apparatus implementing the invention may in particular take the form of a network entity such as a router, a server, a module acting in the network, or a mobile device such as a mobile phone, a smartphone, a PDA, or anything alike.

What is claimed is:

1. A computer-implemented signal processing method to perform a cross-calculation between a first and a second signal, said method comprising:
splitting the first signals into shorter segments of length M;
performing a cross-correlation for the segments of said first signal with said second signal to obtain a plurality of partial cross correlation functions;
obtaining a combined cross-correlation function by combining said partial cross-correlation functions to obtain a combined cross-correlation function;
applying an outlier detection or outlier removal approach to identify or remove those segments which are disturbed or corrupted, and wherein said outlier detection approach comprises:
comparing said individual partial cross-correlation functions with the combined partial cross correlation function to perform a consensus-check in order to check whether the partial cross correlation is in consensus with said combined cross-correlation function, and wherein said method further comprises:
re-combining said partial cross-correlation functions without the ones which based on said consensus-check have been identified as disturbed or corrupted to obtain an less disturbed or less corrupted final cross-correlation function.

2. The method of claim 1, further comprising:
calculating a combined cross-correlation result as a candidate offset, and wherein
if the consensus- check results in that there is no consensus, treating said partial cross-correlation function as an outlier.

3. The method of claim 1, further comprising:
selecting a set of shorter segments of length M;
calculating said combined cross-correlation based on the partial cross correlation functions of said selected set;
performing said consensus-check to identify the outliers among said partial cross-correlation functions of said set;
repeating said step of selecting a set of segments, calculating a combined cross-correlation and performing said consensus check for the individual partial cross-correlations which correspond to said segments until there has been found at least one set of segments which has no outliers or the segment which has the least number of outliers;
calculating the final combined cross-correlation function based on a set of segments which has no outliers or the least number of outliers.

4. The method of claim 3, wherein the combined cross-correlation is calculated based on a plurality of sets of segments which may have different numbers of segments, and wherein said final combined cross-correlation function is calculated based on the set of segments which has the maximum number of segments among the sets of segments for which no outlier has been found.

5. The method of claim 3, wherein a combined partial cross-correlation function yields a candidate offset, and said outlier detection or removal approach comprises one of the following:
comparing the absolute or the relative value of a partial cross-correlation function at the candidate offset with the combined partial cross-correlation value at the candidate offset;
comparing the curvature of the partial cross-correlation function at the candidate offset with the with a certain threshold;
comparing the distance in samples from the candidate offset to the closest significant local maximum of the partial cross-correlation function as to whether it is beyond a certain threshold.

6. The method of claim 1, wherein said outlier detection or removal approach comprises one of the following:
a RANSAC algorithm;
a least median of estimated squares algorithm;
an M-estimator.

7. The method of claim 1, wherein
said outlier detection approach is a RANSAC algorithm in which the model which is to be fitted is the peak of the cross-correlation value between the first and second signal, and the data points used in the fitting are the respective peaks of the partial cross correlation functions, the values of which, after removal of the disturbed partial cross-correlation functions, are combined to obtain the total cross correlation function.

8. The method of claim 7, wherein said consensus check comprises:
checking for each partial cross-correlation function whether the deviation between the peak of the partial cross-correlation functions and the peak of the combined cross-correlation function lies within a certain threshold to identify outliers.

9. The method of claim 1, wherein
said method is applied to find the temporal offset between two video sequences of the same event, possibly taken from different perspectives, said method comprising:
transforming the video data of said two scenes into respective on-dimensional time series;
obtaining the cross-correlation said two time series as defined in one of the preceding claims in order to determine based on the obtained cross-correlation the temporal offset between said two video sequences.

10. The method of claim 9, further comprising:
treating the obtained on-dimensional signals as quasi stationary and/or
normalize them with their global means and standard deviations.

11. The method of claim 1, further comprising:
in order to find the peak candidates in the partial cross correlation functions, applying an approach to mitigate noise, wherein sad approach comprises:
apply morphological closure, or
repeatedly compute the convex hull of the resulting cross-correlation function in order to preserve only its meaningful peaks.

12. A signal processing apparatus for performing a cross-calculation between a first and a second signal, said apparatus comprising:
a module for splitting the first signals into shorter segments of length M;
performing a cross-correlation for the segments of said first signal with said second signal to obtain a plurality of partial cross correlation functions;
a module for obtaining a combined cross-correlation function by combining said partial cross-correlation functions to obtain a combined cross-correlation function;
a module for applying an outlier detection or outlier removal approach to identify or remove those segments which are disturbed or corrupted, and wherein said outlier detection approach comprises:
comparing said individual partial cross-correlation functions with the combined partial cross correlation function to perform a consensus-check in order to check whether the partial cross correlation is in consensus with said combined cross-correlation function, and wherein said apparatus further comprises:
a module for re-combining said partial cross-correlation functions without the ones which based on said consensus-check have been identified as disturbed or corrupted to obtain an less disturbed or less corrupted final cross-correlation function.

13. The apparatus of claim 12, further comprising:
a module for calculating a combined cross-correlation result as a candidate offset, and wherein
if the consensus- check results in that there is no consensus, treating said partial cross-correlation function as an outlier.

14. The apparatus of claim 12, further comprising:
a module for selecting a set of shorter segments of length M;
a module for calculating said combined cross-correlation based on the partial cross correlation functions of said selected set;
a module for performing said consensus-check to identify the outliers among said partial cross-correlation functions of said set;
a module for repeating said step of selecting a set of segments, calculating a combined cross-correlation and performing said consensus check for the individual partial cross-correlations which correspond to said segments until there has been found at least one set of segments which has no outliers or the segment which has the least number of outliers;
a module for calculating the final combined cross-correlation function based on a set of segments which has no outliers or the least number of outliers

15. A computer readable medium having stored or embodied thereon computer program code comprising:
computer program code which when being executed on a computer enables said computer to carry out a method according to claim 1.
